(19) United States
(12) Patent Application Publication
(10) Pub. No.: US 2020/0019609 A1
(43) Pub. Date: Jan. 16, 2020

(54) SUGGESTING A RESPONSE TO A MESSAGE BY SELECTING A TEMPLATE USING A NEURAL NETWORK

(71) Applicant: ASAPP, INC., New York, NY (US)

(72) Inventors: Lili Yu, New York, NY (US); Christopher David Fox, New York, NY (US); Shawn Henry, Longmont, CO (US)

(21) Appl. No.: 16/035,062

(22) Filed: Jul. 13, 2018

(51) Int. Cl. G06F 17/27; G06N 3/04; G06N 3/08

(52) U.S. Cl. CPC G06F 17/2785; G06N 3/0445; G06F 17/278; G06N 3/08; G06N 3/0454

(57) ABSTRACT

A neural network may be used to suggest a response to a received message. One or more messages of a conversation may be processed to generate a conversation feature vector that describes the conversation. The conversation feature vector may be used to select a template from a data store of templates. For example, each template may be associated with a template feature vector, and the template whose template feature vector is closest to the conversation feature vector may be selected. The selected template may have a slot corresponding to a class of words, such as a person's name. A text value may be obtained corresponding to the slot (e.g., a person's name), and the template and the text value may be used to suggest a response to the received message. A person may select the suggested response to cause the suggested response to be sent as a message.

### CROSS REFERENCE TO RELATED APPLICATIONS

This application is a continuation-in-part of U.S. patent application Ser. No. 15/254,086 (Attorney Docket No. ASAP-0001-U04), filed Sep. 1, 2016, and entitled “AUTOMATICALLY SUGGESTING RESOURCES FOR RESPONDING TO A REQUEST,” which claims the benefit of priority to U.S. Provisional Patent Application Ser. No. 62/359,841 (Attorney Docket No. ASAP-0001-P01), filed Jul. 8, 2016, and entitled “SEMANTIC PROCESSING OF USER REQUESTS”.

This application also is a continuation-in-part of U.S. patent application Ser. No. 15/383,603 (Attorney Docket No. ASAP-0002-U01), filed Dec. 19, 2016, and entitled “SUGGESTING RESOURCES USING CONTEXT HASHING”.

This application also is a continuation-in-part of U.S. patent application Ser. No. 15/964,629 (Attorney Docket No. ASAP-0012-U01), filed Apr. 27, 2018, and entitled “REMOVING PERSONAL INFORMATION FROM TEXT USING A NEURAL NETWORK”.

Each of the foregoing applications is incorporated by reference in its entirety.

### FIELD OF THE INVENTION

The present invention relates to processing text of a received message with a neural network to select a template for suggesting a response to the message.

### BACKGROUND

People may exchange messages for various purposes, such as friends coordinating social events or a customer of a company seeking support from a company. The process of entering a response to a message may be cumbersome, especially when a person is busy, multitasking, or using a mobile device with less convenient input capabilities. To make it easier for a person to respond to a message, it may be desired to present suggested responses to the person so that the person may select a suggested response instead of using other input techniques to specify a response.

### BRIEF DESCRIPTION OF THE FIGURES

The invention and the following detailed description of certain embodiments thereof may be understood by reference to the following figures:

FIGS. 1A-C are example user interfaces for suggesting a response to a message.

FIG. 2 is an example system for suggesting a response to a message.

FIG. 3 is a flowchart of an example method for suggesting a response to a message.

FIG. 4 is an example of creating a template from a message.

FIG. 5 is a flowchart of an example method for creating a template from a message.

FIG. 6 is a conceptual example of clustering templates for selecting representative templates for each cluster.

FIG. 7 is an example system for creating templates from a corpus of conversations and selecting representative examples of templates.

FIG. 8 is a flowchart of an example method for creating templates from a corpus of conversations and selecting representative examples of templates.

FIG. 9 is an example system for computing a conversation feature vector from a conversation.

FIG. 10 is an example system for computing a template feature vector from a template.

FIG. 11 is an example system for training mathematical models for suggesting a response to a message.

FIG. 12 is a flowchart of an example method for training neural networks for suggesting a response to a message.

FIG. 13 is a flowchart of an example method for suggesting a response to a message using a neural network.

FIG. 14 is an exemplary computing device that may be used to create templates, select representative templates, train neural networks for suggesting a response to a message, and use neural networks for suggesting a response to a message.

FIG. 15 is an example system for implementing certain aspects of the present disclosure.

### DETAILED DESCRIPTION

People may exchange messages with each other using a variety of techniques and in a variety of situations. For example, a person may type or speak a message to an app running on his device, type or speak a message on a web page, send a text message, or send an email. As used herein, a text message includes any message sent as text including but not limited to a message sent using SMS (short message service) or a special-purpose application (e.g., Facebook messenger, Apple iMessage, Google Hangouts, or WhatsApp). People may exchange messages for any appropriate purpose, such as social interactions, business interactions, or to request customer support from a company. The techniques described herein are not limited to any manner of or purpose for exchanging messages.

Specifying a response to a message may be cumbersome as compared to speaking directly with a person. For example, entering a message with a keyboard (especially on a mobile device) or even dictating a message using automatic speech recognition may take more time and attention than desired and may contain errors or typos.

To facilitate the process of specifying a response to a message, one or more suggested responses may be presented to a person. For example, when presenting a message received from the first person to a second person on a mobile device, suggested responses may be presented under the received message, and the person may quickly select and send a suggested response by tapping or clicking it. Any appropriate techniques may be used to determine and present suggested responses, such as any of the techniques described in U.S. Pat. No. 9,805,371, which is incorporated herein by reference in the entirety.

The process of suggesting responses to a person may be improved using templates. A template may include a combination of text for a response and slot that indicates a class or category of text that may be inserted in place of the slot. For example, suppose a first person sends a message to a second person with the text “What movie do you want to see tonight?” To suggest a response to this message, the following template may be used: “I've been wanting to see <movie>.” The text <movie> is a slot that indicates that the slot should be replaced with the name of a movie. A slot may be specified in a template using any appropriate techniques, and slots need not be specified using angle brackets. A given suggestion may include any number of slots, including zero slots, or more than one slot according to any aspects described herein.

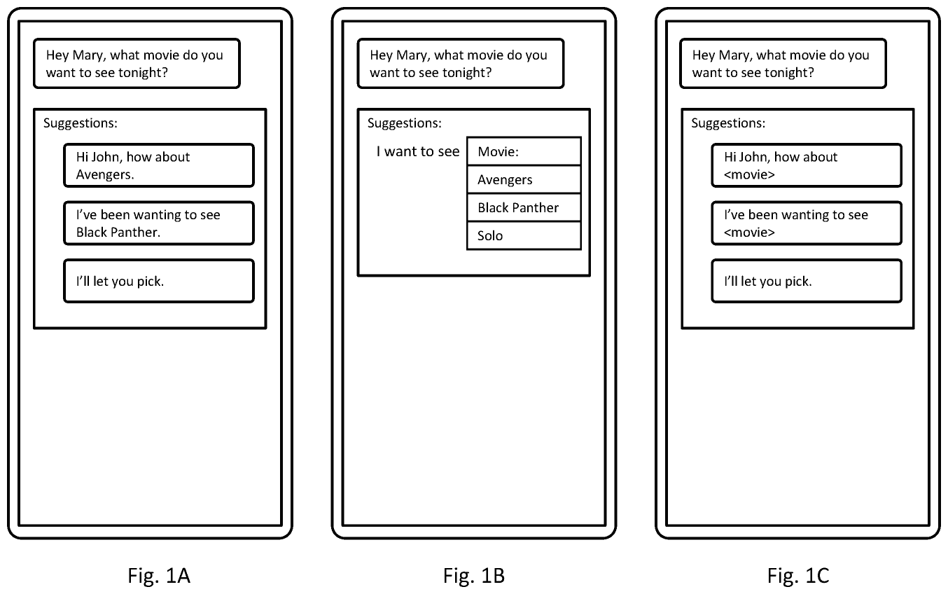

FIGS. 1A-C illustrate several techniques that may be used to suggest responses to users by generating the responses with a template. In each of FIGS. 1A-C, John has sent the message to Mary “Hey Mary, what movie do you want to see tonight?”, and in each figure, suggested responses are presented to Mary using different techniques. FIGS. 1A-C are exemplary, and the techniques described herein are not limited to these examples.

In FIG. 1A, three suggested responses are presented to Mary using three different templates. The first suggestion is generated using a template “Hi<name>, how about <movie>.” The slots in this template were replaced with John's name and the title of a movie before presenting the suggestion to Mary. The second suggestion is generated using the template “I've been wanting to see <movie>.” where the slot was replaced with the name of a movie. The third suggestion is generated using a template “I'll let you pick.” that does not contain any slots. In each case, the slots of the templates were replaced with a single text value.

In FIG. 1B, one suggestion is presented with multiple options for the text value of the movie (or it may be referenced as multiple suggestions). Here, the template “I want to see <movie>.” was presented along with a dropdown menu to allow Mary to select one of three movie titles.

In FIG. 1C, three suggestions are presented to Mary, but some of the slots are left in the suggestions instead of replacing them with text values. The slot for <name> in the first suggestion has been replaced with John's name but the slots for the movie title appear in the suggestions. In this situation, Mary can select a suggested response, and then modify it to replace the slot with her desired movie title.

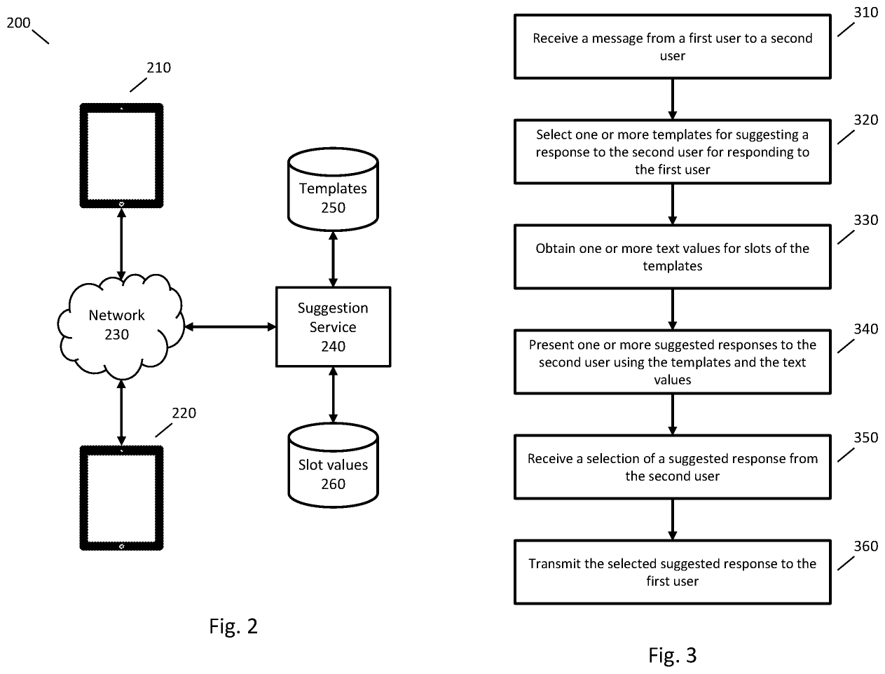

FIG. 2 is an example system 200 for suggesting responses to a user. In system 200, a first user may use a first device 210 to transmit a message to a second user who is using a second device 220. The message may be transmitted using network 230, which may be any appropriate network such as the Internet or cellular data network.

Suggestion service 240 may provide suggestions to the second user using any of the techniques described herein. For example, suggestion service 240 may be integrated with a messaging application (e.g., email or text messaging) used by the second user, may be a standalone service that may be integrated with multiple messaging applications (e.g., an application for a smartphone or other device), or, where the second user is a customer service representative, may be part of a customer service platform used by the second user to respond to the first user.

Suggestion service 240 may access templates data store 250 to obtain one or more templates, may access slot values data store 260 to obtain one or more text values for the slots of the templates, and may generate one or more suggested responses for presentation to the second user. Suggestion service 240 may also receive a selection of a suggested response from the second user and cause the selected suggested response to be transmitted to the first user.

FIG. 3 is a flowchart of an example implementation of using templates for suggesting a response to a message. In FIG. 3 and other flowcharts herein, the ordering of the steps is exemplary and other orders are possible, not all steps are required, steps may be combined (in whole or part) or sub-divided and, in some implementations, some steps may be omitted or other steps may be added. The methods described by any flowcharts described herein may be implemented, for example, by any of the computers or systems described herein.

At step 310, a message from a first user to a second user is received. The message may include text and/or audio and may be sent using any appropriate techniques. Where the message includes audio, automatic speech recognition may be used to obtain text corresponding to the audio. At step 320, one or more templates are selected for suggesting a response to the second user. The templates may include text of a response and one or more slots. At step 330, one or more text values are obtained for the slots of the templates. In some implementations, some templates may include only text and may not include slots. At step 340, one or more suggested responses are presented to the second user using the templates and the text values, such as any of the suggested responses of FIGS. 1A-C. At step 350, a selection of a suggested response is received from the second user. For example, an indication (such as an AJAX request or an HTML post) may be received that identifies a selected suggested response. At step 360, the selected suggested response is transmitted to the first user.

### Template Creation

To suggest responses as described above, a data store of templates may need to be created. Any appropriate techniques may be used to create a data store of templates, such as creating templates manually. In some implementations, a corpus of existing conversations may be used to create templates. Any appropriate corpus of conversations may be used, such as a corpus of conversations logged from a messaging application or a corpus of conversations logged from customer service sessions.

To obtain a data store of templates from a corpus of conversations, the messages in the conversations may be modified to replace certain classes or categories of text with slots (or labels) corresponding to the category. The process of replacing text of a message with a slot may be referred to as redacting the message. Any appropriate techniques may be used to redact a message, such as any of the techniques described in U.S. patent application Ser. No. 15/964,629, filed on Apr. 27, 2018, which is incorporated herein by reference in the entirety.

Any appropriate category of text may be replaced with a slot, including but not limited to personal information. Any appropriate techniques may be used to identify the categories of text to be replaced with slots. For example, a person familiar with the corpus of conversations may manually identify categories of text that commonly appear in the conversations and that would be useful slots for templates. The redaction of one or more categories of text in a message into one or more slots may make the message generally applicable to a larger number of situations. For example, redacting the movie title in “I want to see Avengers” to “I want to see <movie>” creates a template that is applicable for any movie. In some implementations, proper nouns, locations, titles, addresses, phone numbers, or any other type of information may be replaced with one or more slots. In some implementations, information that tends to be a point of variation across messages, and/or information that may be sensitive or confidential may be replaced with one or more slots.

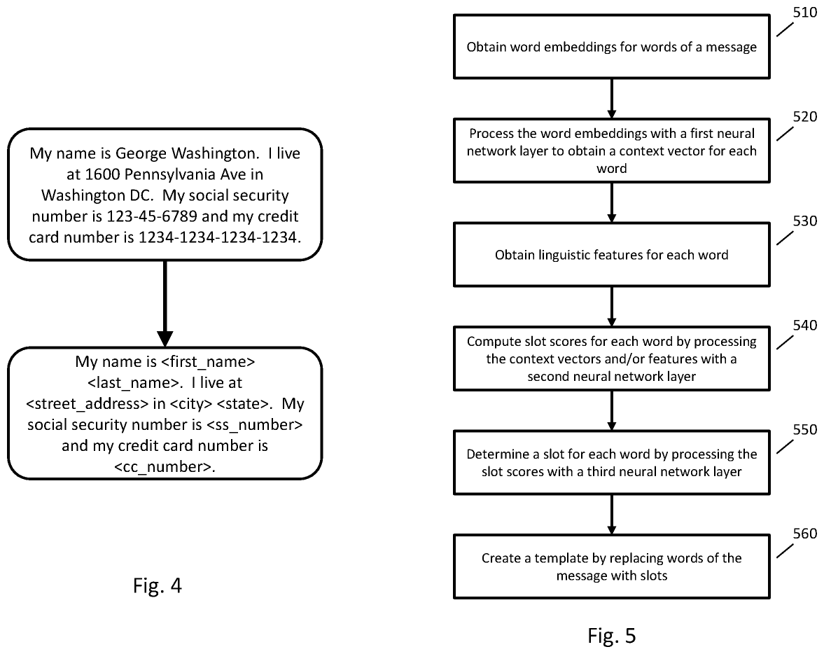

FIG. 4 illustrates an example of creating a template from a message by replacing text of the message with slots. In FIG. 4, the original message includes a first name, a last name, a street address, a city, a social security number, and a credit card number. Each of these items have been replaced with a slot that indicates the category or type of information that was removed. In the example of FIG. 4, the original message is depicted at the top with a transition arrow depicting the creation of the redacted message below.

FIG. 5 is a flowchart of an example implementation of using a neural network to create a template from a message by replacing text of the message with one or more slots.

At step 510, a word embedding is obtained for each word of the message. A word embedding is a vector in an N-dimensional vector space that represents the word but does so in a manner that preserves useful information about the meaning of the word. For example, the word embeddings of words may be constructed so that words with similar meanings or categories may be close to one another in the N-dimensional vector space. For example, the word embeddings for “cat” and “cats” may be close to each other because they have similar meanings, and the words “cat” and “dog” may be close to each other because they both relate to pets. Word embeddings may be trained in advance using a training corpus, and when obtaining the word embeddings at step 510, a lookup may be performed to obtain a word embedding for each word of the message.

Any appropriate techniques may be used to compute word embeddings from a training corpus. For example, the words of the training corpus may be converted to one-hot vectors where the one-hot vectors are the length of the vocabulary and the vectors are 1 in an element corresponding to the word and 0 for other elements. The one-hot vectors may then be processed using any appropriate techniques, such as the techniques implemented in Word2Vec or GloVe software. A word embedding may accordingly be created for each word in the vocabulary. An additional embedding may also be added to represent out-of-vocabulary (OOV) words. In some implementations, word embeddings that include information about the characters in the words may be used, such as the word-character embeddings described in U.S. patent application Ser. No. 15/964,629.

At step 520, the word embeddings are processed with a first neural network layer to obtain a context vector for each word of the message. A context vector for a word may be any vector that represents information about the contexts in which the word is likely to appear, such as information about words that are likely to come before or after the word. The context vector may not be understandable by a person and may be meaningful with respect to the parameters of the neural network.

Any appropriate techniques may be used for the first neural network layer. For example, the first layer may be a recurrent neural network layer, a bidirectional recurrent neural network layer, a convolutional layer, or a layer with long short-term memory (an LSTM layer).

In some implementations, the context vector may be computed using a forward LSTM layer and a backward LSTM layer. A forward LSTM layer may be computed with the following sequence of computations for t from 1 to N (where N is the number of words in the text):

iₜ=σ(Uᵢxₜ+Vᵢhₜ₋₁^{f}+bᵢ)

fₜ=σ(U_{f}xₜ+V_{f}hₜ₋₁^{f}+b_{f})

oₜ=σ(Uₒxₜ+Vₒhₜ₋₁^{f}+bₒ)

gₜ=tan h(U_{g}xₜ+V_{g}hₜ₋₁^{f}+b_{g})

cₜ=fₜ⊙cₜ₋₁+iₜ⊙gₜ

hₜ^{f}=oₜ⊙ tan h(cₜ)

where xₜ represent the word embeddings from step 510, the U's and V's are matrices of parameters, the b's are vectors of parameters, σ is a logistic sigmoid function, and ⊙ denotes element-wise multiplication. The sequence of computations may be initialized with h₀^{f} and c₀ as zero vectors. The hidden state vector hₜ^{f} may represent the context of the t^{th} word going in the forward direction and indicate the context of the t^{th} word with regards to words that come before it.

At each iteration of the above processing, a hidden state vector hₜ^{f} is computed that corresponds to the word represented by word embedding xₜ. The vector hₜ^{f} may be used to compute the context vector as described in greater detail below.

A backward LSTM layer may be computed with the following sequence of computations for t from N to 1 (i.e., the words may be processed in reverse):

iₜ=σ(Ûᵢxₜ+\hat{V}ᵢhₜ₊₁^{b}+\hat{b}ᵢ)

fₜ=σ(Û_{F}xₜ+\hat{V}_{F}hₜ₊₁^{b}+\hat{b}_{F})

oₜ=σσ(Û_{O}xₜ+\hat{V}_{O}hₜ₊₁^{b}+\hat{b}_{O})

gₜ=tan hσ(Û_{G}xₜ+\hat{V}_{G}hₜ₊₁^{b}+\hat{b}_{G})

cₜ=fₜ⊙cₜ₊₁+iₜ⊙gₜ

h_{b}=oₜ⊙ tan h(cₜ)

where xₜ represent the word embeddings from step 510, the Û's and \hat{v}'s are matrices of parameters, the \hat{b}'s are vectors of parameters, and σ and ⊙ are the same as above. The sequence of computations may be initialized with h_{N+1}^{f} and c_{N+1} as zero vectors. The hidden state vector hₜ^{b} may represent the context of the t^{th} word going in the backward direction and indicate the context of the t^{th} word with regards to words that come after it.

The context vectors for the words may be obtained from the hidden state vectors hₜ^{f} and hₜ^{b}. For example, the context vector for the t^{th} word may be the concatenation of hₜ^{f} and hₜ^{b} and may be represented as hₜ.

At step 530, linguistic features may be obtained for each word of the message. Linguistic features for a word may include any features that relate to the phonology, morphology, syntax, or semantics of a word. Any appropriate linguistic features may be used, such as the following:
whether the word starts with a capital letter;
whether the word consists of all capital letters;
whether the word has all lower case letters;
whether the word has non-initial capital letters;
whether the word contains digits;
whether the word contains punctuation;
prefixes and suffixes of the word;
whether the word has an apostrophe near the end;
the word's part of speech (POS) label (encoded as a 1-of-k vector); or
the word's chunk label (encoded as a 1-of-k vector).

The context vector for a word and the linguistic features for a word may be combined to create a feature vector for the word, which may be denoted as fₜ. Any appropriate techniques may be used to combine the context vector and the linguistic features, such as concatenation. In some implementations, step 530 is optional and the feature vector for a word may be the same as the context vector for the word.

At step 540, a vector of slot scores is computed for each word. Each element of the vector of slot scores may be a score that corresponds to a slot, such as any of the slots described above, and indicate a match between the word and the class of words corresponding to the slot. The vector of slot scores may also include an element that indicates that the word doesn't correspond to any of the slots.

The slot scores may be computed using any appropriate techniques. In some implementations, the slot scores may be computed using a second layer of a neural network. Any appropriate neural network layer may be used, such as a multi-layer perceptron. In some implementations, the slot scores may be computed as

yₜ=Wₛfₜ+bₛ

or

yₜ=σ(Wₛfₜ+bₛ)

where fₜ is the feature vector of the t^{th} word as computed above, Wₛ is a matrix of parameters, bₛ is a vector of parameters, and σ is a nonlinearity.

At step 550, a slot is determined for each word by processing the slot scores for the words. The best matching slot for a word may depend on nearby slots. For example, where a word corresponds to a <street_address> slot, it may be more likely that a subsequent word corresponds to the <city> slot or the <state> slot. Accordingly, processing the sequence of slot scores may result in more accurate slots.

A sequence model may be used to process the slot scores to determine a slot for each word. A sequence model is any model that determines a slot for word using information about the word in a sequence of words, such as using the slot scores for one or more previous or subsequent words. Any appropriate sequence model may be used, such as a conditional random field (CRF), a higher-order CRF, a semi-Markov CRF, a latent dynamical CRF, a discriminative probabilistic latent variable model, a Markov random field, a hidden Markov model, or a maximum entropy Markov model.

In some implementations, a sequence model may be implemented with a CRF by maximizing a score across all possible sequences of slots:

$$s ( {y}_{1} , … , {y}_{N} ; {l}_{1} , … , {l}_{N} ) = {A}_{{l}_{N} , {l}_{N + 1}} + {\sum }_{t = 1}^{N} {A}_{{l}_{t - 1} , {l}_{t}} + {y}_{t , {l}_{t}}$$

where Aₗ_{₁}_{,l}_{₂} is a transition probability for transitioning from a word with slot l₁ to a subsequent work with slot l₂, the value y_{t,l}_{₁} is the slot score indicating a match between the t^{th} word and slot l₁, and s indicates a score for the sequence of slots l₁, . . . , l_{N}.

Any appropriate techniques may be used to find a sequence of slots that produces a highest score given the slot scores for the words. In some implementations, a dynamic programming algorithm, such as a beam search or the Viterbi algorithm may be used.

At step 560, a template may be created by replacing text of the message with a corresponding slot. For words that do not correspond to any slot, the words may remain unchanged. For words that correspond to a slot, the words may be replaced with a representation of the slot, such as replacing an address with “<street_address>”. In some implementations, sequences of a slot may be replaced with a single instance of that slot. For example, where the text includes “I live at 1600 Pennsylvania Avenue”, the processing above may replace each word of the street address with a slot indicating that the removed word corresponds to a street address. The text after the above processing may thus be “I live at <street_address> <street_address> <street_address>”. The three identical slots may be replaced with a single instance of the slot, and the text after step 560 may thus be “I live at <street_address>”.

### Template Selection

After performing the operations of FIG. 5, a number of templates are available that may be used to suggest responses to messages. In some implementations, the number of available templates may be too large and it may be desired to reduce the number of templates. Having too many templates may increase the processing time for selecting a template for suggesting a response to a message.

To reduce the number of templates, a clustering operation may be performed on the templates so that similar templates are in the same cluster. One or more templates may then be selected to represent all of the templates in the cluster. For example, a first template may be “I'd like to see <movie>”, and a second template may be “I would like to see <movie>”. These two templates would likely be in the same cluster and one of these two templates would likely be sufficient to represent the cluster or a portion of the cluster.

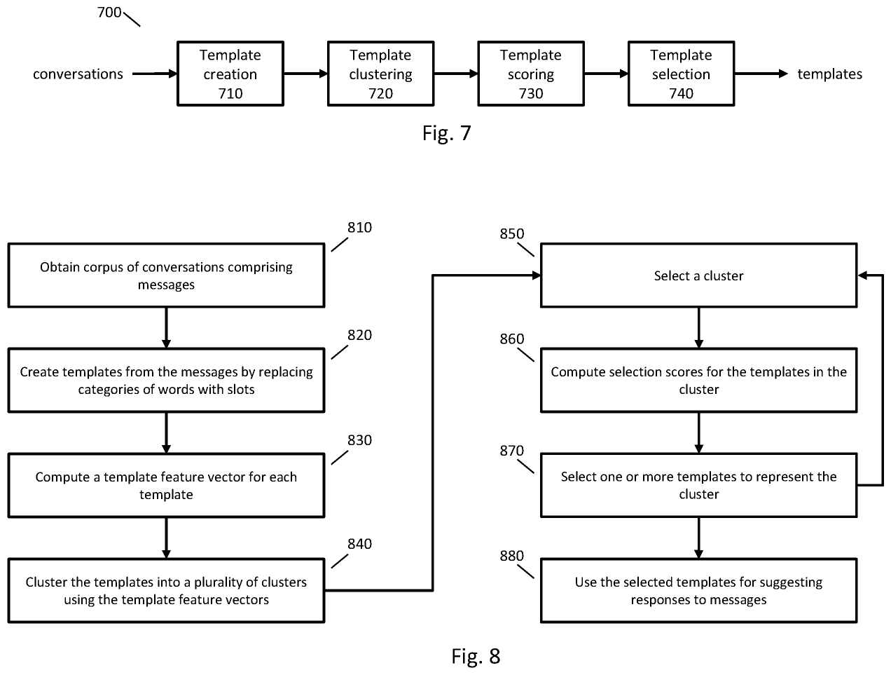

FIG. 7 illustrates a system 700 for selecting a set of response templates that may be used to suggest responses to messages.

In system 700, template creation component 710 receives a corpus of conversations (each conversation including one or more messages) or messages and processes the messages to create a template for each message. Any appropriate techniques may be used to create a template from a message, such as any of the techniques described herein.

Template clustering component 720 may receive a set of templates and cluster them so that similar templates are in the same cluster. To cluster the templates, a template feature vector may be computed for each template that represents the content of the template. Any appropriate template feature vector may be computed, such as any template feature vector described herein. Template clustering component 720 may then use the template feature vector to cluster the templates so that templates with template feature vectors that are close to each other are likely in the same cluster. Any appropriate clustering techniques may be used, such as any of the clustering techniques described herein.

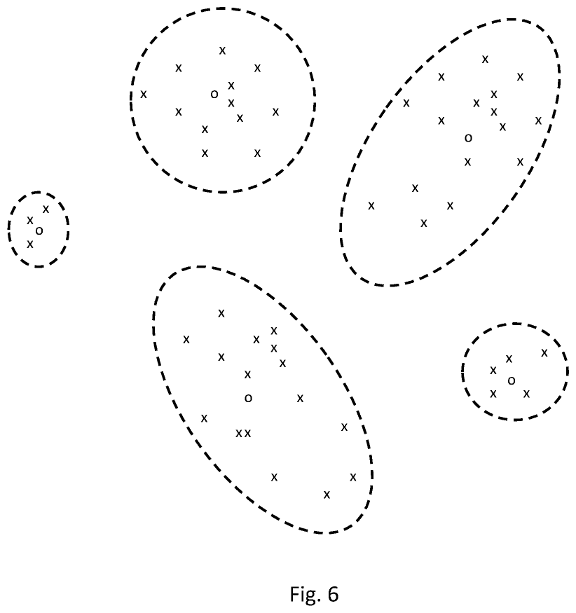

FIG. 6 illustrates a conceptual example of clustering templates. In FIG. 6, each template is represented as an “x” or “o” in two dimensions using a two-dimensional template feature vector (some implementations would use longer template feature vectors). The dashed circles indicate five different clusters that have been determined from the template feature vector. Each of the five clusters would likely have templates whose content is similar to the other templates in the cluster.

Template scoring component 730 may compute a selection score for each template. A selection score for a template may indicate, in some sense, a goodness or quality of the template. For example, a selection score could be the number of times the template appeared in the corpus of conversations. Any appropriate template selection score may be computed, such as any of the template selection scores described herein.

Template selection component 740 may use the selection scores select one or more templates from each cluster to represent the cluster. Any appropriate techniques may be used to select templates using selection scores, such as any of the template selection techniques described herein. For example, a number of templates having the highest selection scores may be selected. The selected templates may then be used to suggest responses to messages. In FIG. 6, the selected templates are represented with an “o”.

FIG. 8 is a flowchart of an example implementation of selecting a set of templates that may be used to suggest responses to messages.

At step 810, a corpus of conversations is obtained where each conversation includes one or more messages. In some implementations, a corpus of messages may be used instead where the messages are not necessarily part of a conversation. Any appropriate corpus of conversations or messages may be used, such as a history of messages exchanged between users of a messaging application or a history of messages between customers and customer service representatives.

At step 820, templates may be created for the messages of the corpus by replacing words of the messages with slots. Any appropriate techniques may be used to create a template from a message, such as any of the techniques described herein.

At step 830, a template feature vector is computed for each template. A template feature vector may be any vector that represents a template such that templates with similar content will also have template feature vectors that are close to one another (e.g., using a distance or other measure of similarity). Any appropriate techniques may be used to compute a template feature vector, such as the template feature vector described in greater detail below.

For the template feature vectors and any other vectors described herein, a vector comprises any format of storing data, and the data does not need to be stored in the form of a vector. The data in a vector may be stored in any appropriate form, such as a matrix or a tensor.

At step 840, the templates are clustered using the template feature vectors. Any appropriate clustering techniques may be used. In some implementations, the templates may be clustered using a K-means algorithm, such as a spherical K-means algorithm. In some implementations, the templates may be clustered using a hierarchical clustering algorithm, such as HDBSCAN (hierarchical density-based spatial clustering of applications with noise). Any appropriate number of clusters may be created, and the number of clusters may be fixed in advanced or determined dynamically during the clustering process.

At steps 850 to 870, processing is performed for each of the clusters. For example, the clusters may be processed in a loop to perform the operations on each cluster. At step 850, a cluster is selected.

At step 860, a selection score is computed for each template in the cluster. As noted above, a selection score for a template may indicate, in some sense, a goodness or quality of the template. Any appropriate selection scores may be used, such as the following scores.

In some implementations, a selection score for a template may be a centrality score computed as the distance (or similarity) between the template feature vector of the template and the centroid of the cluster. The centroid of the cluster may be determined using any appropriate techniques, such as by computing an average of template feature vectors of the templates of the cluster. Any appropriate distance or similarity may be used, such as a Euclidean distance or a cosine similarity.

In some implementations, a selection score for a template may be a frequency score computed as the number of times the template appears in the training corpus (e.g., the number of messages that produced the template at step 820).

In some implementations, a selection score for a template may be a probability score computed as a probability of the template occurring as determined by a language model (and possibly normalized according to the length of the template). With this technique, templates with more commonly used language may have higher scores than templates with less commonly used language.

In some implementations, a selection score for a template may be computed using the messages that appeared before the message that generated the template. Consider the i^{th} template in the cluster that may be denoted as tᵢ. This template was generated from a message of a conversation. Denote the messages of this conversation, prior to the message that generated that template, collectively as Cᵢ.

A selection score may be computed by comparing template tᵢ with the conversation that came before it Cᵢ. To compare the two, a template feature vector may be computed for template tᵢ and the template feature vector may be denoted as yᵢ. In addition, for each template, we can compute a conversation feature vector that describes the conversation C₁ that occurred previous to the template, and the conversation feature vector may be denoted as xᵢ.

Accordingly, for each template in the cluster, a template feature vector may be computed that describes the template, and a conversation feature vector may be computed that describes the state of the conversation at the time the message corresponding to the template was used. Any appropriate techniques for computing a conversation feature vector may be used, such as the techniques described in greater detail below. The template feature vector may be the same template feature vector used at step 830 or may be a different template feature vector.

In some implementations, a template score for a template may be a retrieval similarity score computed using (a) the similarity of the template feature vector to the conversation feature vector corresponding to the template and also (b) the similarity of the template feature vector to the conversation feature vectors of other templates in the cluster. Consider template tᵢ and template tⱼ. A similarity between the template feature vector of template tⱼ (denoted yⱼ) and the conversation feature vector of template tᵢ (denoted xᵢ) may be computed as

sᵢⱼ=xᵢ^{T}yⱼ

where the superscript T indicates a vector transpose. In some implementations, sᵢⱼ may be computed as a cosine similarity.

A selection score for template tⱼ (denoted sⱼ) may then be computed using the similarity between the template feature vector of template tⱼ and the conversation feature vectors of the templates in the cluster. For example, the selection score for template tⱼ may be computed as the average (or any other combination) of the similarities:

$${s}_{j} = \frac{1}{N} {\sum }_{i = 1}^{N} {s}_{ij}$$

Accordingly, a template whose template feature vector is similar to the conversation feature vectors of many templates may have a higher selection score than a template whose template feature vector is similar to the conversation feature vectors of a smaller number of templates.

In some implementations, a template selection score may be a TFIDF (term frequency-inverse document frequency) score computed using a similarity between TFIDF features of a template and a conversation or between TFIDF features of a template and another template. For example, similarities may be computed as

sᵢⱼ=TFIDF(Cᵢ)^{T}TFIDF(tⱼ)

or

sᵢⱼ=TFIDF(tᵢ)^{T}TFIDF(tⱼ)

where TFIDF is a function that computes the inverse document frequency weighted vector of n-gram counts of the words in the template (tⱼ or tᵢ) or the previous messages (Cᵢ).

A selection score for template tⱼ may then be computed using the similarity between the TFIDF vector of template tⱼ and the TFIDF vectors of the previous messages. Alternatively, a selection score for template tⱼ may be computed using the similarity between the TFIDF vector of template tⱼ and the TFIDF vectors of other templates in the cluster. A selection score for template tⱼ (denoted sⱼ) may be computed from a combination of the sᵢⱼ, for example, as indicated above.

In some implementations, a template selection score may be a machine translation score computed using machine translation metrics, such as BLEU, ROGUE, or METEOR. These metrics may indicate a similarity in language between two templates or between a template and previous messages. A similarity between template tⱼ and the previous messages Cᵢ may be computed as

Sᵢⱼ=MT(Cᵢ,Tⱼ)

Where MT is a function that computes a machine translation metric (such as BLEU, ROGUE, or METEOR). A selection score for template tⱼ (denoted sⱼ) may be computed from a combination of the sᵢⱼ, for example, as indicated above.

In some implementations, a selection score for a template may be computed as a combination of two or more of the above scores. For example, a selection score for template could be a weighted sum of a centrality score, a frequency score, and a retrieval similarity score. Any appropriate weighting scheme may be used and any appropriate techniques may be used to determine the weights.

After step 860, a selection score has been computed for each template in the cluster.

At step 870, one or more templates are selected to represent the cluster using the selection scores. Any appropriate techniques may be used to select one or more templates to represent the cluster. In some implementations, a fixed number of templates having the highest selection scores may be selected or all templates having a selection score above a threshold may be selected.

In some implementations, templates may be selected in a manner to account for variations of the templates within a cluster. For example, if a cluster included two different subgroups of templates where templates in each subgroup were similar to each other, then it may be desirable to select at least one template from each subgroup. In certain embodiments, a second template from a second subgroup may be selected despite having a lower selection score than a first template from a first subgroup, to ensure representation of the second subgroup, and/or for any of the reasons described herein. Such techniques may be referred to as submodular techniques and they may be implemented to maximize coverage and minimize redundancy of the different types of templates in the cluster. For example, templates may be selected using a submodular maximization algorithm, such as the algorithm described in Multi-document summarization via budgeted maximization of submodular functions, HLT '10 Human Language Technologies: The 2010 Annual Conference of the North American Chapter of the Association for Computational Linguistics, pp. 912-920, which is herein incorporated by reference.

In some implementations, all of the templates may be selected and used in production to suggest responses to messages. In the production system, a count may be maintained of the number of times each template is used, and the set of templates may later be pruned to remove less commonly used templates.

After step 870, processing may proceed back to step 850 to select one or more templates for another cluster. After all clusters have been processed, processing may proceed to step 880 where the selected templates may be used for suggesting responses to messages, such as by using any of the techniques described herein.

### Conversation Feature Vectors and Template Feature Vectors

Above, conversation feature vectors and template feature vectors are used to select representative templates from the clusters, and these same vectors may also be used for suggesting responses to a message. Now described are techniques for computing conversation feature vectors and template feature vectors.

A conversation feature vector is computed by processing one or more messages of a conversation with a mathematical model, and the conversation feature vector represents information about the state and/or information in the conversation. In some implementations, the conversation feature vector may be computed by a neural network and thus may not be interpretable by a person.

A template feature vector is computed by processing a template (or alternatively from a message that generated the template) with a mathematical model, and the template feature vector indicates which conversations are likely a good match for the template. In some implementations, the template feature vector may be computed by a neural network and thus may not be interpretable by a person.

The conversation feature vectors and template feature vectors may be computed so that when a template feature vector is close (e.g., using a distance or other similarity measure) to a conversation feature vector, then the corresponding template is likely a good candidate for suggesting a response to the most recent message in the conversation.

As indicated above, template feature vectors and conversation feature vectors may also be used to select templates from a cluster of templates. For example, where a template feature vector is close to the conversation feature vectors of many conversations, the corresponding template may provide a good representation of the templates in the cluster, and the template may be selected, as described above.

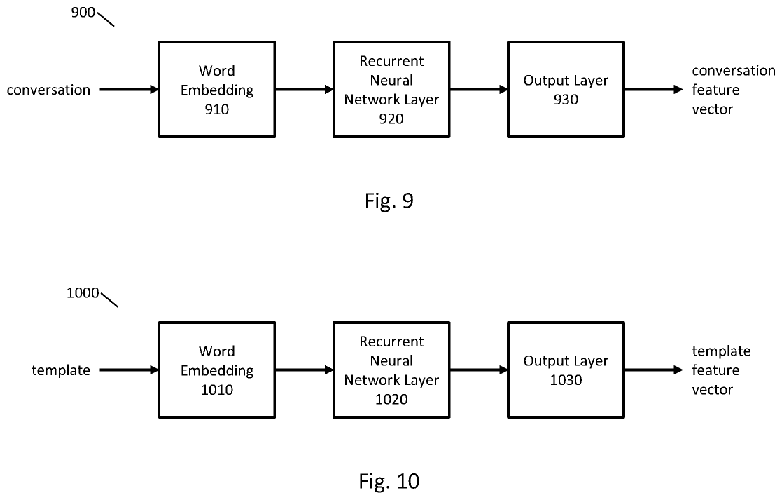

In some implementations, a conversation feature vector may be computed by processing one or more messages of a conversation with a neural network. FIG. 9 is an example system 900 for computing a conversation feature vector from one or more messages of a conversation.

Word embedding component 910 obtains a word embedding of words of the conversation. The word embeddings may be computed using any appropriate techniques, such as the techniques described above. The word embeddings may be computed in advance, and word embedding component 910 may retrieve stored word embeddings corresponding to words of the conversation. In some implementations, the messages of the conversation may have been converted into templates (e.g., by replacing classes of words with slots), and word embedding component 910 may obtain word embeddings for the words and slots of the templates.

Recurrent neural network layer component 920 may process the words of the conversation and output one or more vectors that represent the conversation. Recurrent neural network layer may be implemented using any appropriate recurrent neural network (RNN), such as an RNN with long short-term memory, an RNN with a gated recurrent unit, an RRN with a simple recurrent unit (as described in U.S. patent application Ser. No. 15/789,241, which is incorporated herein by reference in the entirety), a bidirectional RNN, or any RNN described herein or in any of the documents incorporated by reference.

In some implementations, RNN layer component 920 may sequentially process the word embeddings of the conversation (e.g., processing the first word of the first message, the second word of the first message, and so forth until all word embeddings are processed). During the processing of each word embedding, a hidden state vector of the RNN layer may be updated and/or an output vector may be computed.

In some implementations, RNN layer component 920 may process only a fixed number of the most recent words in the conversation. Where the number of words in the conversation is less than the fixed number, then the words embeddings may be supplemented with a special <pad> word embedding so that there are at least the fixed number of word embeddings. In some implementations, a special <message> word embedding may be inserted after each message of the conversation to indicate where one message ends and the next message begins.

In some implementations, RNN layer component 920 may separately process the messages of the conversation to generate a message feature vector for each of the messages, and then process the sequence of message feature vectors to compute a conversation feature vector. For example, a first recurrent neural network layer may process the word embeddings of a message, and a second recurrent neural network layer may process the message feature vectors to compute the conversation feature vector. RNN layer component 920 may compute message and conversation feature vectors using any of the techniques described in Ser. No. 15/383,603, which is incorporated herein by reference in the entirety.

RNN layer component 920 may output one or more vectors, such as a final hidden state vector or a hidden state vector for each processed word.

In some implementations, RNN layer component 920 may include multiple sequential or parallel RNN layers, such as four sequential RNN layers. In some implementations, RNN layer component 920 may be replaced by a different neural network layer, such as a convolutional neural network layer.

Output layer component 930 may process the output of RNN layer component 920 to generate the conversation feature vector. In some implementations, output layer component 930 may output the final hidden state vector of RNN layer component 920 (and in this instance output layer component 930 may be omitted). In some implementations, output layer component 930 may compute a combination of each of the hidden state vectors of RNN layer component 920, such as computing an average of the hidden state vectors.

In some implementations, output layer component 930 may be a structured self-attention layer or use structured self-attention to compute the conversation feature vector from the output of RNN layer component 920. Denote the hidden state vectors of RNN layer component as h₁, h₂, . . . , h_{L}. A conversation feature vector, denoted as x, may be computed as

$${u}_{i}^{j} = tanh ( {U}^{j} {h}_{j} + {b}_{u}^{j} )$$

$${v}_{i}^{j} = {V}_{2}^{j} tanh ( {V}_{1}^{j} {h}_{j} + {b}_{v}^{j} )$$

$${a}_{i}^{j} = \frac{exp ( {v}_{i}^{j} )}{{\sum }_{k} exp ( {v}_{k}^{i} )}$$

$${x}^{j} = {\sum }_{i} {a}_{i}^{j} {u}_{i}^{j}$$

$$x = [ {x}^{1} , {x}^{2} , … , {x}^{H} ]$$

where H is the number of attention heads; j ranges from 1 to H; U^{j}; V₁^{j}, V₂^{j}, bᵤ^{j}, and bᵥ^{j} are matrices or vectors of parameters. A structured self-attention layer may allow the conversation feature vector to better incorporate information from earlier messages in the conversation. For example, without a structured self-attention layer, recent messages may have greater importance than earlier messages, but with a structured self-attention layer, important information in earlier messages may be more likely to be captured by the conversation feature vector.

The conversation feature vector computed by output layer component 930 may then be used for selecting templates as described herein.

In some implementations, a template feature vector may be computed by processing a template (or the message that generated the template) with a neural network. FIG. 10 is an example system 1000 for computing a template feature vector from a template.

Word embedding component 1010 may perform any of the functionality described above to obtain word embeddings for the words of the template. Where the template contains one or more slots, a word embedding may be obtained for each of the slots as well. A word embedding for a slot may be determined using any of the techniques described herein to compute a word embedding for a word. For example, the slot “<name>” may simply be treated as a word when the word embeddings are computed. In some implementations, word embeddings for slots may be determined in other ways, such as a person selecting a word embedding for a slot, or computing the word embedding for a slot using the word embeddings of various words that may correspond to the slot (e.g., by computing the average of the word embeddings).

Recurrent neural network layer component 1020 may process the word embeddings using any of the RNN layers described herein. For example, RNN layer component 1020 may sequentially process the word embeddings of the template to output one or more vectors, such as a final hidden state vector of the recurrent neural network or multiple hidden state vectors of the neural network. In some implementations, RNN layer component 1020 may be the same as RNN layer component 920.

In some implementations, RNN layer component 1020 may include multiple sequential or parallel RNN layers, such as four sequential RNN layers. In some implementations, RNN layer component 1020 may be replaced by a different neural network layer, such as a convolutional neural network layer.

Output layer component 1030 may process the output of RNN layer component 1020 to compute the template feature vector. Output layer component 1030 may perform any appropriate operations to compute a vector that is the same length as the conversation feature vector as computed by system 900. For example, where RNN layer component 1020 outputs a single vector (e.g., a final hidden state vector) that is already the same length as the conversation feature vector, then output layer component may be omitted and the output of RNN layer component 1020 may be used as the template feature vector. In some implementations, output layer component 1030 may include a linear projection layer to process the output of RNN layer component 1020 and compute a template feature vector that is the same length as the conversation feature vector. In some implementations, output layer component 1030 may be the same as output layer component 930.

The template feature vector computed by output layer component 1030 may then be used for selecting templates as described herein.

### Training

The processing described above includes various parameters, such as the parameters of system 900 for computing a conversation feature vector and the parameters of system 1000 for computing a template feature vector. Any appropriate techniques may be used to train these parameters.

In some implementations, training may be performed using a training corpus of conversations. Each conversation may include a different number of messages. The training may be performed be iterating over each of the conversations, iterating over each response in each conversation, computing a template feature vector for each response, computing a conversation feature vector for the messages before each response, and updating the model parameters so that the conversation feature vector and the template feature vector are close to each other.

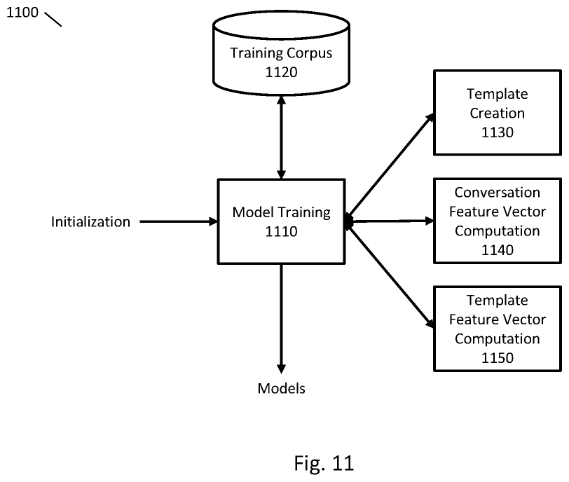

FIG. 11 is an example system 1100 for training parameters of a mathematical model using a training corpus. In FIG. 11, model training component 1110 can be initialized to perform training using training corpus 1120. Model training component can iterate over the messages in training corpus 1120 to train one or mathematical models using any of the techniques described herein. Model training component 1110 can interact with template creation component 1130 to create a template from a message using any of the techniques described herein. Model training component 1110 can interact with conversation feature vector computation component 1140 to compute a conversation feature vector from one or more messages using any of the techniques described herein. Model training component 1110 can interact with template feature vector computation component 1150 to compute a template feature vector from a template using any of the techniques described herein. Model training component 1110 may then output one or more mathematical models that may be used to suggest responses to a message, such as a first mathematical model for computing a conversation feature vector from one or more messages and a second mathematical model for compute a template feature vector from a template.

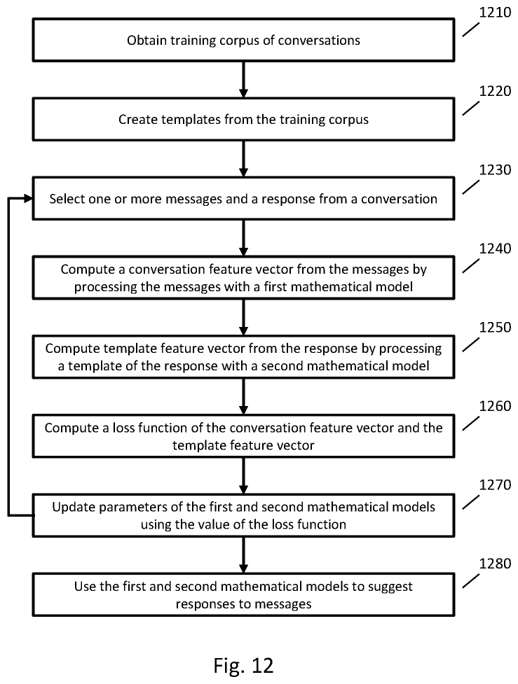

FIG. 12 is a flowchart of an example implementation of training one or more mathematical models for suggesting response to a message. At step 1210, a training corpus of conversations is obtained, such as any of the conversations described herein.

At step 1220, templates are created for messages of the training corpus, such as by using any of the techniques described herein. In some implementations, a template may be created for each message of the training corpus, for each message that is a response to another message (e.g., excluding first messages of conversations), or for some subset of the training corpus.

Steps 1230 to 1270 iterate over responses in the training corpus along with one or more messages of the conversation that preceded the response. Steps 1230 to 1270 may be performed for each response of the training corpus or some subset of the training corpus.

At step 1230 a response is selected from the training corpus along with one or more messages that preceded the response in a conversation.

At step 1240, a conversation feature vector is computed from the one or more messages by processing the one or more messages with a first mathematical model, such as the neural network of FIG. 9.

At step 1250, a template feature vector is computed from the response by processing a template created from the response (or by processing the response) with a second mathematical model, such as the neural network of FIG. 10.

At step 1260, a loss function is computed from the conversation feature vector and the template feature vector. Any appropriate loss function may be computed. In some implementations, a loss function will have a high value when the conversation feature vector and the template feature vector are close to each other and a low value when they are not (or vice versa). For example, any distance or similarity measure could be used as a loss function.

In some implementations, a loss function may be computed using template feature vectors for other templates. For example, let x be the conversation feature vector computed at step 1240, y be the template feature vector computed at step 1250, and let ŷᵢ be template feature vectors for other templates for i from 1 to N (collectively, the template feature vectors of “other templates”). The other templates may be selected using any appropriate techniques. For example, the other templates may be selected randomly from a set of available templates.

In some implementations, the loss function may be a margin loss computed as

$${L}_{m} = max ( 0 , \frac{1}{N} {\sum }_{i} {x}^{T} {\hat{y}}_{i} + M - {x}^{T} y )$$

where M is a hyper-parameter that represents the margin. The vectors x, y, and ŷᵢ may be normalized to unit vectors.

In some implementations, the loss function may be a classification loss function computed as

L_{c}=x^{T}y−log(exp(x^{T}y)+Σᵢ exp(x^{T}ŷᵢ))

where log is a natural logarithm.

At step 1270, parameters of first mathematical model and the second mathematical model are updated using the value of the loss function. Any appropriate optimization techniques may be used to update the parameters, such as stochastic gradient descent. In some implementations, the parameters of first mathematical model and the second mathematical model may be updated using batches of training data. For example, step 1230 through 1260 may be computed for a batch of training data, and then step 1270 may be performed simultaneously for the batch of training data.

After step 1270, it may be determined whether additional training data remains to be processed. Where additional training data remains to processed, processing may proceed to step 1230 to process additional training data. Where all training data has been processed, processing proceeds to step 1280. In some implementations, the training corpus may be processed multiple times during steps 1230 to 1270.

At step 1280, the first mathematical model and the second mathematical model may be used to suggest responses to messages, such as using any of the techniques described herein.

### Implementation

After templates have been selected and mathematical models have been trained, the mathematical models and templates may be used in a production system, such as system 200 of FIG. 2, to suggest responses to messages.

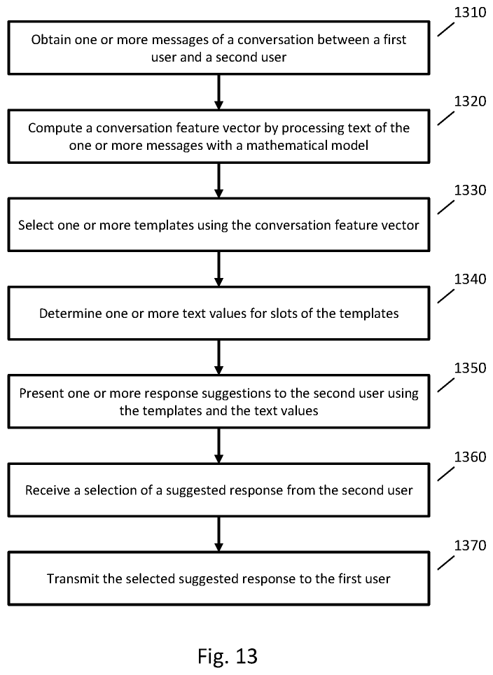

FIG. 13 is a flowchart of an example implementation of suggesting a response to a message. At step 1310, one or more messages of a conversation between a first user and a second user are obtained, such as by using any of the techniques described herein. At step 1320, a conversation feature vector is computed by processing text of the one or more messages with a mathematical model, such as any of the neural networks described herein.

At step 1330, one or more templates are selected from a data store of templates using the conversation feature vector. The one or more templates may be selected using any appropriate techniques.

In some implementations, a selection score may be computed for each template in the data store, and one or more templates with the highest scores may be selected. For example, a fixed number of highest scoring templates may be selected, or all templates with a score above a threshold may be selected.

Any appropriate selection score may be used. In some implementations, a selection score for a template may be computed as an inner product of the conversation feature vector and the template feature vector of the template:

S=X^{T}y

where x is the conversation feature vector computed at step 1320 and y is a template feature vector of a template. In some implementations, the vectors x and y may be normalized to unit vectors and the selection score may be computed as a cosine similarity between the conversation feature vector and the template feature vector.

In some implementations, the selection scores for all templates may be computed using a single matrix vector multiplication. A matrix may be created by combining the template feature vectors for all available templates and this matrix may be multiplied by the conversation feature vector to obtain a vector of selection scores, where each element of the vector of scores is a selection score for a corresponding template. In some implementations, an introselect algorithm may be used to select a number of highest scoring templates.

In some implementations, hierarchical techniques and/or vector quantization may be used to more efficiently select a template from the data store (in particular, where there are a larger number of templates). With hierarchical techniques, the templates may be divided into multiple groups with a vector that represents each group (e.g., the group vector may be the centroid of the template feature vectors in the group). The group vectors may be used to select a group of templates, and then a template within the group may be selected. Similarly, multiple levels of groups may be used with a group including multiple subgroups, and each subgroup including multiple templates.

At step 1340, one or more text values are determined for slots of the template. For example, where a template includes the slot “<name>”, one or more possible names may be determined as candidates for that slot. In some implementations, step 1340 may be skipped where the selected templates do not include slots or where it is not desired to determine text values for the slots (e.g., for the implementation depicted in FIG. 1C). In some implementations, text values may be obtained for some slots but not for other slots. For example, techniques for determining text values for slots may be available for some slots but not for other slots.

Any appropriate techniques may be used to select one or more text values for the slots, and the techniques for selecting text values for a slot may depend on the implementation or on the particular slot. The following are non-limiting examples of selecting text values for a slot. A fixed set of text values may be selected for a slot. For example, where a company has three products, text values for the names of the company's three products may always be selected. No text values may be selected for a slot. In this instance, a user may be required to provide a text value for the slot. Text values may be selected by processing one or more messages of the conversation with named entity recognition. For example, where a message refers to the title of a movie, and a template has a slot “<movie>”, the text values of the slot may be selected from the previous message in the conversation. Text values may be selected from a profile or other information relating to the users participating in the conversation. For example, where a template includes the slot “<name>”, the text value may be the name of the other person in the conversation as obtained from a profile of the other user or some other available information about the other user. Text values may be selected from a knowledge base or other source of information. For example, where a template has a slot “<movie>”, text values may be retrieved from a knowledge base that lists movies currently playing in the vicinity of the users participating in the conversation. In some implementations or instances, a slot may have a text value selected for a first suggestion, and the same slot may have no text value selected for a second suggestion.

At step 1350, one or more suggested responses are presented to the second user using the selected templates and/or text values. The suggested responses may be determined and presented using any appropriate techniques, such as any of the techniques presented in FIGS. 1A-C or otherwise described herein. Presenting a suggested response may include presenting the full text of a response (i.e., without slots) as depicted in FIG. 1A, presenting text of a response along with a mechanism to select a text value from possible text values for a slot as depicted in FIG. 1B, presenting text of a response along with a placeholder for the slot that may be filled in by a user as depicted in FIG. 1C, or any combination of the above for different slots of a template.

At step 1360, a selection of a suggested response is received from the second user. Any appropriate techniques may be used to allow the second user to select a suggested response (e.g., clicking or tapping to select a suggested response, selecting a text value from a dropdown menu to select a response, or selecting and editing text of a response) and to transmit information about the selected response. For example, the text of the selected suggested response may be transmitted or an identifier representing the selected suggested response may be transmitted. The selected suggested response, or response message, may be a message corresponding to, based upon, and/or edited from the suggested response. The response message described as corresponding to the suggested response indicates the response message has a relationship to the suggested response, but the response message may include other information (e.g., as selected or edited by the user) and/or may be more than one message (e.g., not a one-to-one correspondence with the suggested response).

At 1370, the selected suggested response is transmitted as a message to the first user, such as by using any of the messaging techniques described herein.

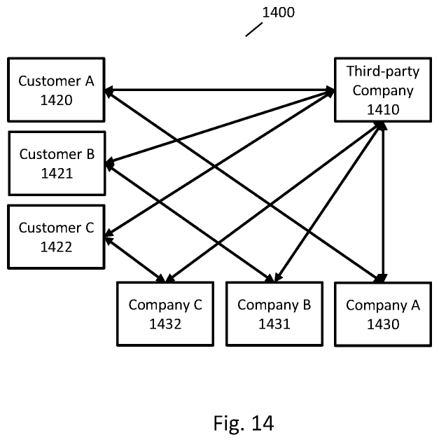

In some implementations, a third-party company may provide services to other companies to suggest messages to customers, employees, or other people affiliated with the companies. For example, a company may provide a messaging application for use by its customers, and the company may use services of the third-party company to process messages of conversations and suggest responses to the customers. For another example, a company may provide customer support to its customers via a messaging platform, and the company may use the services of the third-party company to suggest responses to customer service representatives and/or customers. A company may find it more cost effective to use the services of the third-party company than to implement its own suggestion services. FIG. 14 illustrates an example architecture that may be used by a company to obtain assistance from a third-party company in providing customer support to its customers. A similar architecture may be used by a company that provides a messaging platform to its customers.

FIG. 14 illustrates a system 1400 that allows a third-party company 1410 to provide response suggestion services to multiple companies. In FIG. 14, third-party company 1410 is providing response suggestion services to company A 1430, company B 1431, and company C 1432. Third-party company 1410 may provide response suggestion services to any number of companies.

Customers of each company may seek customer support from a company where the support process uses the services of third-party company 1410. For example, customer A 1420 may be seeking support from company A 1430, customer B 1421 may be seeking support from company B 1431, and customer C 1422 may be seeking support from company C 1432. It may or may not be apparent to the customers whether they are using services of third-party company 1410.

Third-party company 1410 may assist a company in providing response suggestion services in a variety of ways. In some implementations, third-party company 1410 may assist in connecting a customer with a customer service representative working on behalf of the company. For example, third-party company 1410 may select a customer service representative, may provide a user interface to a customer to make it easier for a customer to request support, and may provide a user interface to a customer service representative to assist the customer service representative in responding to a request of a customer. A customer service representative may have any appropriate relationship with the company on behalf of which it is providing customer support. For example, a customer service representative may be an employee or contractor of a company and providing customer support to only customers of that company, or a customer service representative may be providing services to multiple companies and providing support to customers of the multiple companies at the same time.

The communications between third-party company 1410, customers, and companies may be architected in a variety of ways. In some implementations, all communications between a customer and a company may be via third-party company 1410 and there may not be any direct connection between the customer and the company. In some implementations, third-party company 1410 may communicate with the company but may not communicate directly with the customer. In some implementations, a customer may communicate directly with the company and also third-party company 1410.

Where a customer is connected to both a company and third-party company 1410, each of the two connections may be used for different kinds of requests. For example, where the customer is interacting with the company in a way that does not require the services of third-party company 1410 (e.g., navigating a web site of the company), the customer may use the network connection with the company. Where the customer is interacting with the company in a way that uses the services of third-party company 1410, the customer may use the network connection with third-party company. It may not be apparent to the customer whether the customer is using a network connection with the company or with third-party company 1410.

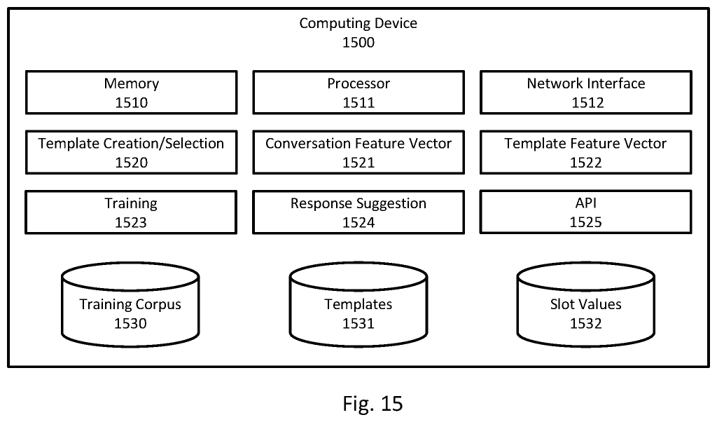

FIG. 15 illustrates components of one implementation of a computing device 1500 for implementing any of the techniques described above. In FIG. 15, the components are shown as being on a single computing device, but the components may be distributed among multiple computing devices, such as a system of computing devices, including, for example, an end-user computing device (e.g., a smart phone or a tablet) and/or a server computing device (e.g., cloud computing).

Computing device 1500 may include any components typical of a computing device, such as volatile or nonvolatile memory 1510, one or more processors 1511, and one or more network interfaces 1512. Computing device 1500 may also include any input and output components, such as displays, keyboards, and touch screens. Computing device 1500 may also include a variety of components or modules providing specific functionality, and these components or modules may be implemented in software, hardware, or a combination thereof. Below, several examples of components are described for one example implementation, and other implementations may include additional components or exclude some of the components described below.

Computing device 1500 may have a template creation/selection component 1520 that may create templates from messages and select a set of templates for use in a response suggestion service using any of the techniques described herein. Computing device 1500 may have a conversation feature vector component 1521 that may compute a conversation feature vector describing one or more messages of a conversation using any of the techniques described herein. Computing device 1500 may have a template feature vector component 1522 that may compute a template feature vector from a template using any of the techniques described herein. Computing device 1500 may have a training component 1523 that may train one or more mathematical models (such as neural networks) for computing conversation and template feature vectors using any of the techniques described herein. Computing device 1500 may have a response suggestion component 1524 that may process one or more messages of a conversation to select one or more templates and/or one or more slot values using any of the techniques described herein. Computing device 1500 may have an application programming interface (API) component 1525 that may interface with software running on a user device to present suggested responses to users using any of the techniques described herein.

Computing device 1500 may include or have access to various data stores. Data stores may use any known storage technology such as files or relational, non-relational databases, or any non-transitory computer-readable media. Computing device 1500 may have training corpus data store 1530 that may be used create and select templates and/or to train mathematical models for a suggestion service. Computing device 1500 may have templates data store 1531 that may store templates that may be used to suggest responses to a user. Computing device 1500 may have text values data store 1532 that may store text values that may be used to suggest responses to a user.

It can be seen that the techniques described herein allow an interface to provide suggested responses for a user to respond to messages from another user. The methods and systems described provide for a convenient user interface that reduces the time to interact with messages, and allows the user to focus on important aspects of the messages to provide for more thoughtful and accurate communication. Additionally, the methods and systems described allow a customer service representative working with a company, or working with multiple companies to provide more accurate and responsive service.

The methods and systems described herein may be deployed in part or in whole through a machine that executes computer software, program codes, and/or instructions on a processor. “Processor” as used herein is meant to include at least one processor and unless context clearly indicates otherwise, the plural and the singular should be understood to be interchangeable. Any aspects of the present disclosure may be implemented as a computer-implemented method on the machine, as a system or apparatus as part of or in relation to the machine, or as a computer program product embodied in a computer readable medium executing on one or more of the machines. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A computer-implemented method for suggesting a response to a received message by processing the received message with a neural network, the method comprising:
receiving text of one or more messages between a first user and a second user;
computing a conversation feature vector by processing the text of the one or more messages with a neural network;
computing a first selection score that indicates a similarity between the conversation feature vector and a first template feature vector, wherein:
the first template feature vector is associated with a first template,
the first template comprises text of a first response and a first slot, and
the first slot corresponds to a first class of words;
selecting the first template from a data store of templates using the first selection score;
obtaining a first text value corresponding to the first slot;
presenting a first suggested response to the second user, wherein the first suggested response corresponds to the first template and the first text value;
receiving a selection of the first suggested response from the second user;
generating a response message corresponding to the first suggested response; and
transmitting the response message to the first user.

2. The computer-implemented method of claim 1, wherein:
presenting the first suggested response to the second user comprises replacing the first slot with the first text value.

3. The computer-implemented method of claim 1, comprising:
obtaining a second text value corresponding to the first slot;
presenting a second suggested response to the second user, wherein the second suggested response corresponds to the first template and the second text value; and
wherein receiving the selection of the first suggested response from the second user comprises receiving a selection of the first text value.

4. The computer-implemented method of claim 1, wherein computing the conversation feature vector comprises:
obtaining a word embedding for each word of the text of the one or more messages; and
processing the word embeddings with the neural network; and
wherein the neural network comprises a recurrent neural network layer.

5. The computer-implemented method of claim 1, wherein the conversation feature vector comprises at least one of:
a final hidden state vector of a recurrent neural network layer;
an average of hidden state vectors of the recurrent neural network layer; or
an output of a structured self-attention layer.

6. The computer-implemented method of claim 1, wherein selecting the first template from the data store of templates comprises computing a selection score between the conversation feature vector and each template feature vector of the data store of templates.

7. The computer-implemented method of claim 1, wherein the first text value is obtained by performing named entity recognition on the one or more messages.

8. The computer-implemented method of claim 1, wherein the first text value is obtained from (i) a profile associated with the first user or the second user or (ii) a knowledge base.

9. A system for suggesting a response to a received message, the system comprising:
at least one server computer comprising at least one processor and at least one memory, the at least one server computer configured to:
receive text of one or more messages between a first user and a second user;
compute a conversation feature vector by processing the text of the one or more messages with a neural network;
compute a first selection score that indicates a similarity between the conversation feature vector and a first template feature vector, wherein:
the first template feature vector is associated with a first template,
the first template comprises text of a first response and a first slot, and
the first slot corresponds to a first class of words;
select the first template from a data store of templates using the first selection score;
obtain a first text value corresponding to the first slot;
present a first suggested response to the second user, wherein the first suggested response corresponds to the first template and the first text value;
receive a selection of the first suggested response from the second user;
generate a response message corresponding to the first suggested response; and
transmit the response message to the first user.

10. The system of claim 9, wherein the at least one server computer is configured to:
the first user is a customer of a company requesting assistance from the company; and
the second user is a customer service representative.

11. The system of claim 10, wherein the system is implemented by a second company that provides services to the company.

12. The system of claim 9, wherein the data store of templates is obtained by:
obtaining a corpus of messages, where each message of the corpus of messages was sent by a user to another user in response to another message; and
generating a plurality of templates by processing the corpus of messages to replace words corresponding to the first class of words with the first slot.

13. The system of claim 12, wherein generating the plurality of templates by processing the corpus of messages comprises processing the corpus of messages with a second neural network to identify the words corresponding to the first class of words.

14. The system of claim 12, wherein the data store of templates is obtained by:
clustering the plurality of templates into a plurality of clusters; and
selecting one or more representative templates from each cluster of the plurality of clusters.

15. The system of claim 9, wherein the at least one server computer is configured to:
obtain a training corpus of conversations wherein the training corpus comprises a first conversation, wherein the first conversation comprises a response and one or more messages prior to the response;
compute a training conversation feature vector using the one or more messages;
compute a training template feature vector using the response; and
train the neural network using the training conversation feature vector and the training template feature vector.

16. One or more non-transitory computer-readable media comprising computer executable instructions that, when executed, cause at least one processor to perform actions comprising:
receiving text of one or more messages between a first user and a second user;
computing a conversation feature vector by processing the text of the one or more messages with a neural network;
computing a first selection score that indicates a similarity between the conversation feature vector and a first template feature vector, wherein:
the first template feature vector is associated with a first template,
the first template comprises text of a first response and a first slot, and
the first slot corresponds to a first class of words;
selecting the first template from a data store of templates using the first selection score;
obtaining a first text value corresponding to the first slot;
presenting a first suggested response to the second user, wherein the first suggested response corresponds to the first template and the first text value;
receiving a selection of the first suggested response from the second user;
generating a response message corresponding to the first suggested response; and
transmitting the response message to the first user.

17. The one or more non-transitory computer-readable media of claim 16, the actions comprising:
selecting a second template from the data store of templates using the conversation feature vector, wherein the second template comprises text of a second response and the first slot; and
presenting a second suggested response to the second user, wherein the second suggested response corresponds to the second template and the first text value.

18. The one or more non-transitory computer-readable media of claim 16, wherein the first template comprises a second slot corresponding to a second class of words, and wherein the actions comprise obtaining a second text value corresponding to the second slot.

19. The one or more non-transitory computer-readable media of claim 16, wherein computing the conversation feature vector comprises:
computing a first message feature vector by processing the text of a first message with the neural network;
computing a second message feature vector by processing text of a second message with the neural network; and
computing the conversation feature vector by processing the first message feature vector and the second message feature vector with a second neural network.

20. The one or more non-transitory computer-readable media of claim 16, wherein computing the first selection score between the conversation feature vector and the first template feature vector comprises computing a cosine similarity of the conversation feature vector and the first template feature vector.
